(19) United States
(12) Patent Application Publication
(10) Pub. No.: US 2010/0212917 A1
(43) Pub. Date: Aug. 26, 2010

(54) MULTI APPLICATION FIRE SPRINKLER

(76) Inventor: RALPH R. MEHR, Tel Aviv (IL)

Correspondence Address: Prof. Rafi Mehr, P.O.Box 21666, Tel Aviv, 61216, omitted

(21) Appl. No.: 12/709,460

(22) Filed: Feb. 20, 2010

Related U.S. Application Data
(60) Provisional application No. 61/155,161, filed on Feb. 25, 2009.

(51) Int. Cl. A62C 31/00

(52) U.S. Cl. 169/37

(57) ABSTRACT

A multi application fire sprinkler (MAFS), including a conical element, with a shape selected from a variety of options, comprising a component of a variable orifice, and arm and spiral spring, which can be calibrated, for the purpose of granting the MAFS with qualities which enable its use in any application and in any working conditions which require a fire sprinkler.

### REFERENCE TO CROSS-RELATED APPLICATION

This application claims priority from U.S. Provisional Application No. 61/155,161, filed on Feb. 25, 2009, herein incorporated by reference in its entirety.

### FIELD OF THE INVENTION

The present invention relates to automatic fire sprinklers, more particularly, to automatic fire sprinklers having a variable, self-adjusting orifice, and more particularly to a Multi Application Fire Sprinkler (MAFS).

### BACKGROUND OF THE INVENTION

The first automatic sprinkler patent known in the field is entitled “automatic fire extinguisher” to Henry S. Parmelee, granted: Aug. 17, 1874.

Since then, many improvements have been made in fire extinguishment systems in general, and particularly in sprinklers. An elaborate explanation is provided by Prof. Ralph R. Mehr, the inventor as of the present invention, in his paper: “The Theory and Practice of Variable Orifice in Automatic Sprinkler Systems”, published in the Journal of the National Fire Sprinkler Association, MAY/JUNE2008/No. 148 pages 73-77, which is incorporated by reference for all purposes as if fully set forth herein.

The term “automatic” is used here in the sense that the sprinkler is activated without human intervention when the sprinkling of water or any other extinguishment fluid is required for fires.

Typically, an automatic fire sprinkler includes a body, an inlet connected to a source of pressurized water, or fire retardant fluid, a passageway between the inlet and a flow-adjusting orifice, which also serves as an outlet.

Additionally, a plug closing the orifice when the sprinkler is in standby condition is held in place by a thermally sensitive element, or by another name, a heat sensitive fusible element. When the temperature is elevated to a pre-determined value, the thermally sensitive element disintegrates. Consequently, the water pressure urges the plug away from the orifice, enabling the sprinkler to discharge. A supported deflector distributes the water stream flowing from the orifice, dispersing the stream over the region to be protected by the sprinkler.

FIG. 1a of the prior art illustrates an automatic fire fixed orifice sprinkler 101, having a deflector 11 disposed in a predetermined distance from the sprinkler cylindrical body 13, in an inactive standby state.

FIG. 1b of the prior art illustrates the automatic fire sprinkler 101, in an active state, when it is spraying and dispersing water droplets 12.

Typically, each automatic fire sprinkler 101 includes a deflector disposed to disperse the fluid emanating from a discharge orifice in a predetermined pattern.

FIG. 2 of the prior art illustrates an adjustable deflector sprinkler 102 as described in U.S. Pat. No. 5,036,923, to Shea, Sr., Entitled: “Fire sprinkler with adjustable deflector”, granted: Aug. 6, 1991.

The adjustable deflector sprinkler 102, has a deflector assembly 11, which in an inactive state of the sprinkler, is attached to a cylindrical body 13, granting esthetical and additional practical benefits.

The adjustable deflector sprinkler 102 has a cylindrical body 13 having an inlet 16 and a fixed orifice 17.

The deflector assembly 11 is attached to the cylindrical body 13 by a pair of connector struts 15. The struts 15 accommodate movement of the deflector assembly 11, between an inactive position shown by dashed lines in FIG. 2 and an active position shown by solid lines therein.

When there is no fire in close proximity, a eutectic sensor material (not shown) retains an actuator assembly in place. However, at a predetermined environmental temperature, the eutectic sensor material melts, allowing the deflector assembly 11 to move downward to the active position.

From the initial invention of the automatic sprinkler, the orifice of the sprinkler has had a fixed value defined by the diameter and shape. This characteristic creates some limitations to the sprinkler performance, such as:

Different applications (i.e. different occupancies, such as residential versus storage), require different sprinklers.

In a process of fire development, more water throughput from the initial sprinklers opened would enable faster control of the fire, but flow is limited by the orifice.

Each sprinkler exhibits optimal performance at limited range of pressures.

Furthermore, use of sprinklers can often cause severe damage in itself, if the quantity of sprinkled water or fire retardant fluid is excessive,

The various requirements of automatic fire sprinklers are defined in the National Fire Protection Association (NFPA) 13 Standard for the installation of sprinkler systems, which was also adopted by American National Standards Institute (ANSI). This standard is periodically revised.

Generally, the water flow rate from a sprinkler is determined by the formula:

Q=K\sqrt{P}

wherein:
Q is a flow rate, (of a fluid flow through an orifice of a sprinkler);
K is the K-factor, a coefficient (dependent upon a geometry and dimensions of the sprinkler, determined by standard flow testing); and
P is a fluid pressure, (at the inlet to the sprinkler).

Different applications require different water flows, i.e., sprinklers that have different K-factors K, and/or different inlet water pressures P. For standard coverage, the most commonly used sprinklers have a K-factor of 5.6, while extended coverage applications use sprinklers having larger K-factors of 8 to 11.2, which have correspondingly larger orifices.

One advanced sprinkler is the low-pressure fast response (LPFR) sprinkler, also known as the early suppression fast response (ESFR) sprinkler Characteristically, this sprinkler has K-factors between 14 and 25.2, a short time of response, and high water flow rates.

Typical prior art examples of these LPFR or ESFR sprinklers are U.S. Pat. No. 5,829,532, and U.S. Pat. No. 6,502,643, both entitled “Low pressure, early suppression fast response sprinklers”, both to Meyer, et al., U.S. Pat. No. 6,059,044 to Fischer, entitled “Fire protection sprinkler and deflector”, and U.S. Pat. No. 6,336,509 to Polan, et al., entitled “Low pressure fast response bulb sprinklers”.

The use of sprinklers having greater K-factors reduces the required water pressure at the inlet, and therefore obviates the need of installing more robust and capital-intensive systems.

In addition, a lower water pressure results in larger droplets being produced by the deflector. The larger droplets have a higher momentum that assists them in being deflected further from the sprinkler, thereby extending the coverage area.

Alternatively, for a given water pressure, the use of sprinklers having larger orifices increases the flow of water through each sprinkler, thus reducing the required number of sprinklers for the requisite coverage area.

In prior art sprinkler systems, after a fire starts, the thermally sensitive element of the closest sprinkler disintegrates at the pre-determined temperature, permitting Q₁ of water to discharge at inlet pressure P₁. If the fire has not been extinguished by this sprinkler, additional heat is generated and spreads, and a second sprinkler discharges. As a result, Q₁ and P₁ of the first sprinkler decrease to Q₂ and P₂, since now the same water source is feeding two sprinklers. As additional sprinklers discharge, the values of Q and P of the first and second sprinklers further decrease. Final Q and P values are reached only when no additional sprinklers discharge.

In a constant value K-factor sprinklers the inlet pressure P changes according to the number of discharging sprinklers, the amount of water discharged by the first sprinkler, according to the above mentioned formula, is

Q₁=K\sqrt{P₁} Q₂=K\sqrt{P₂} etc.

Consequently, in the first stage of the operational pattern, the amounts Q₁ and Q₂ are greater than the amount discharged by the first-opened sprinkler when more sprinklers are in operation.

In order to improve sprinkler efficiency, and broaden the range of operation, an automatic fire sprinkle was invented by Prof. Ralph R. Mehr, the inventor of the present invention, which is described in U.S. Pat. No. 7,237,619 entitled “Automatic Fire Sprinkler Having a Variable Orifice”, Filed: Jul. 23, 2003, granted: Jul. 3, 2007, which is incorporated by reference for all purposes as if fully set forth herein.

The variable orifice of the variable orifice sprinkler (103), is responsive to the water inlet pressure of the sprinkler.

FIG. 3a of the prior is a longitudinal cross sectional view, schematic drawing of a variable orifice sprinkler 103, in a non-flowing condition, the sprinkler having a variable orifice (18) which is adjusted by an inner conical element 20.

Variable orifice sprinkler 103 has a cylindrical body 13 with a threaded connection 14 attached to the water piping system (not shown in the drawing), a deflector assembly 11 tightly closing the cylindrical body 13 in a non-flowing position, thereby preventing water flow through a variable orifice (18) (shown open in FIG. 3b). Two arms 21 allow free longitudinal movement of the deflector assembly 11, so as to increase and decrease the distance between the deflector assembly 11 and an end side of the cylindrical body 13, and spiral springs 22 are bound around the arms 21.

A conical element 20 is associated with the deflector assembly 11. In a non-flowing position the conical element 20 completely penetrates into the cylindrical body 13, closing the variable orifice 18.

Preferably, arms 21 and springs 22 are protected from external dirt and physical damages by an external box 25.

FIG. 3b of the prior is a longitudinal cross sectional view, schematic drawing of the variable orifice sprinkler 103, in a flowing condition.

The water or other fire retardant fluid is pressurized into the cylindrical body 13 through inlet 16, and as long as the variable orifice 18 is blocked, there is no flow through the variable orifice sprinkler 103.

When a fire starts, and heat evolves from the burning materials, the fusible element (19) fuses, deflector assembly 11 is urged out by the pressure, opening a gap between deflector assembly 11 and cylindrical body 13, and most of conical element 20 is moved out of cylindrical body 13, such that variable orifice 18 is practically at its maximum possible opening. Arms 21 are now at their extreme position outside box 25, and springs 22 are in their most restricted position

As the pressure of the water flowing through the variable orifice 18 is decreased, springs 22 urge the deflector assembly 11 towards the cylindrical body 13. The cross-sectional area of the penetrating section of conical element 20 increases with decreasing pressure, thereby reducing the cross-sectional area of the water flow-path and further restricting the flow of water discharged by the variable orifice sprinkler 103.

None of the prior art overcomes the limitations specified above. It would be highly advantageous to have an improved automatic fire sprinkler system that optimizes the quantity of water or fire retardant fluid sprayed during fire, to decrease the size of the core fire and the time required for extinguishment.

It would be of further advantage if such a sprinkler of such a system had such qualities that would enable its calibration to be adaptable to the place where it is installed, such as a residential home or a storage warehouse containing goods including flammable materials.

### SUMMARY OF THE INVENTION

According to the teaching of the present invention there is provided an automatic multi application fire sprinkler having a variable orifice, which is adaptable for efficient work in a wide range of flow pressures, and can be calibrated for a wide range of fire purposes, thus sparing the need for automatic fire sprinklers with different characteristics.

Standard automatic fire sprinklers are inefficient and can cause severe water damage when they are not specifically suited for working purpose and conditions. The automatic multi application fire sprinkler enables use of a single type of automatic fire sprinkler, by means of a mechanical structure which controls the supply of water flowing through it during its activation, for efficient performance even under different work pressures. Furthermore, its performance can be well adapted by providing the option for calibration of element parameters and replacing elements.

According to the present invention there is provided a multi application fire sprinkler including: (a) a cylindrical body, having an inlet at one end and a variable orifice at a second end of the cylindrical body, and a cylindrical body disc; (b) at least one arm, wherein the arm is mounted through a cylindrical body disc hole; (c) at least one spiral spring disposed around the at least one arm; (d) a deflector assembly disposed on the at least one arm; (e) a movement limiter mechanism disposed on the at least one arm, wherein the at least one spiral spring is located between the cylindrical body disc and the movement limiter mechanism; and (f) a conical element disposed on the deflector assembly, wherein the combination of the conical element, the at least one arm, and the at least one spiral spring determines a water flow rate through the variable orifice according to water pressure.

According to a further feature of the described embodiments the conical element is a linear conical element.

According to further features in the described embodiments the conical element is a narrow conical element.

According to further features in the described embodiments the conical element is a wide conical element.

According to a further feature of the described embodiments the conical element can be selected from a group consisting of a linear conical element, a wide conical element, and a narrow conical element, and wherein the combination of the conical element, the at least one arm, and the at least one spiral spring determines a water flow rate through the variable orifice according to water pressure.

According to another further feature of the described embodiments, in an inactive state of the multi application fire sprinkler the at least one spiral spring is practically at its natural length, which practically equals a possible movement length of the deflector assembly up to its full compression, wherein one end of the at least one spiral spring is in touch with the cylindrical body disc, and wherein a second end of the at least one spiral spring is in touch with the movement limiter mechanism.

According to still another further feature of the described embodiments in an inactive state of the multi application fire sprinkler the at least one spiral spring is compressed relative to its natural state, wherein a possible movement range of the deflector assembly is shorter than a length of the at least one spiral springs natural length, wherein one end of the at least one spiral spring is in touch with the cylindrical body disc, and wherein a second end of the at least one spiral spring is in touch with the movement limiter mechanism.

According to still another further feature of the described embodiments, in an inactive state of the multi application fire sprinkler the at least one spiral spring is practically at its natural length, wherein the natural length is shorter than a possible movement range of the deflector assembly to a full compression length of the at least one spiral spring.

According to still another further feature of the described embodiments, a position of an element of the movement limiter mechanism on the at least one arm can be manually adjusted for adaptation to desired functions and working conditions of the multi application fire sprinkler.

According to still another feature of the described embodiments the element of the movement limiter mechanism is a nut.

According to still another feature of the described embodiments the multi application fire sprinkler is configured such that the at least one spiral spring can be manually replaced easily, with an alternative spiral spring.

According to still another features in the described embodiments the linear conical element has a cross section diameter, perpendicular to a symmetry axis of the linear conical element, which equals the mathematical product of A and a constant c sub 2, wherein A equals a constant c sub 1 minus h, wherein h is a distance measured from the cone base, towards a cone vertex of the linear conical element.

According to still another feature of in the described embodiments the constant c sub 1 practically equals 2.0, and wherein the constant c sub 2 practically equals 0.5245.

According to still another feature of the described embodiments the narrow conical element has a cross section diameter, perpendicular to a symmetry axis of the narrow conical element, which equals the mathematical product of D to the power of n3 and a constant c sub 6, wherein D equals a constant c sub 5 minus h, wherein h is a distance, measured from the cone base, towards a cone vertex of the narrow conical element.

According to still another feature of the described embodiments the n3 practically equals 2.0, wherein the constant c sub 5 practically equals 2.0, and wherein the constant c sub 6 practically equals 0.262.

According to still another feature of the described embodiments the wide conical element has a cross section diameter, perpendicular to a symmetry axis of the wide conical element equals B to the power of n2, wherein B equals a constant c sub 3 minus C, wherein C equals the mathematical product of h to the power of n1 and a constant c sub 4, wherein h is a distance, measured from the cone base, towards a cone vertex of the wide conical element.

According to still another feature of the described embodiments the n1 practically equals 0.5, wherein the n2 is practically equals 0.5, wherein the constant c sub 3 practically equals 1.1, and wherein the constant c sub 4 practically equals 0.778.

Additional objects and advantages of the invention will be set forth in part in the description which follows and, in part, will be obvious from the description, or may be learned by practice of the invention.

### BRIEF DESCRIPTION OF THE DRAWINGS

The invention is herein described, by way of example only, with reference to the accompanying drawings, wherein:

FIG. 1a of the prior art illustrates an automatic fire fixed orifice sprinkler, having a deflector disposed to in a predetermined distance from the sprinkler body, in an inactive or standby state.

FIG. 1b of the prior art illustrates the automatic fire sprinkler, in an active state, when it is spraying and dispersing water droplets.

FIG. 2 of the prior art illustrates the adjustable deflector sprinkler of Shea.

FIG. 3a of the prior art is a longitudinal cross sectional view, schematic drawing of a variable orifice sprinkler, in a non-flowing condition, the sprinkler having a variable orifice adjusted by an inner conical element.

FIG. 3b of the prior art is a longitudinal cross sectional view, schematic drawing of a variable orifice sprinkler, in a flowing condition.

FIG. 4a is a side view schematic illustration of an illustrative, exemplary embodiment of a multi application fire sprinkler, according to the present invention, upon which section plane a-a is marked.

FIG. 4b is an isometric schematic illustration of an illustrative, exemplary embodiment of a multi application fire sprinkler, according to the present invention, upon which section plane b-b is marked.

FIGS. 5a, 5b, and 5c are a-a schematic longitudinal cross sectional views illustration of an illustrative, exemplary embodiment of the multi application fire sprinkler (MAFS), according to the present invention, wherein in the inactive state spiral springs are in their natural length, which practically equals the length of possible movement of the deflector assembly up to their full compression.

FIGS. 6a, 6b, and 6c are a-a schematic longitudinal cross sectional views illustration of an illustrative, exemplary embodiment of the MAFS, according to the present invention, wherein in the inactive state, the spiral springs compressed to a length shorter than their natural length.

FIGS. 7a, 7b, and 7c are a-a schematic longitudinal cross sectional views illustration of an illustrative, exemplary embodiment of the MAFS, according to the present invention, wherein in the inactive state, the spiral springs are at their natural length with no load, which is shorter than the range of possible movement of the deflector assembly up to their full compression.

FIGS. 8a, 8b, and 8c, are a-a schematic longitudinal partial cross sectional views illustration of an illustrative, exemplary embodiment of the multi application fire sprinkler (MAFS), according to the present invention, showing three conical elements, each with a different spatial shape.

FIG. 9 is a graph which compares the water flow rate as a function of the pressure of the MAFS according to the present invention, equipped with a narrow conical element, with the water flow rate of two prior art fire sprinklers.

FIG. 10 is a side views illustration of an illustrative, exemplary embodiment of arm, spiral spring, and deflector assembly of the MAFS, according to the present invention, in three different states.

FIG. 11 is a b-b schematic lateral partial cross sectional view illustration of an illustrative, exemplary embodiment of the multi application fire sprinkler (MAFS), according to the present invention.

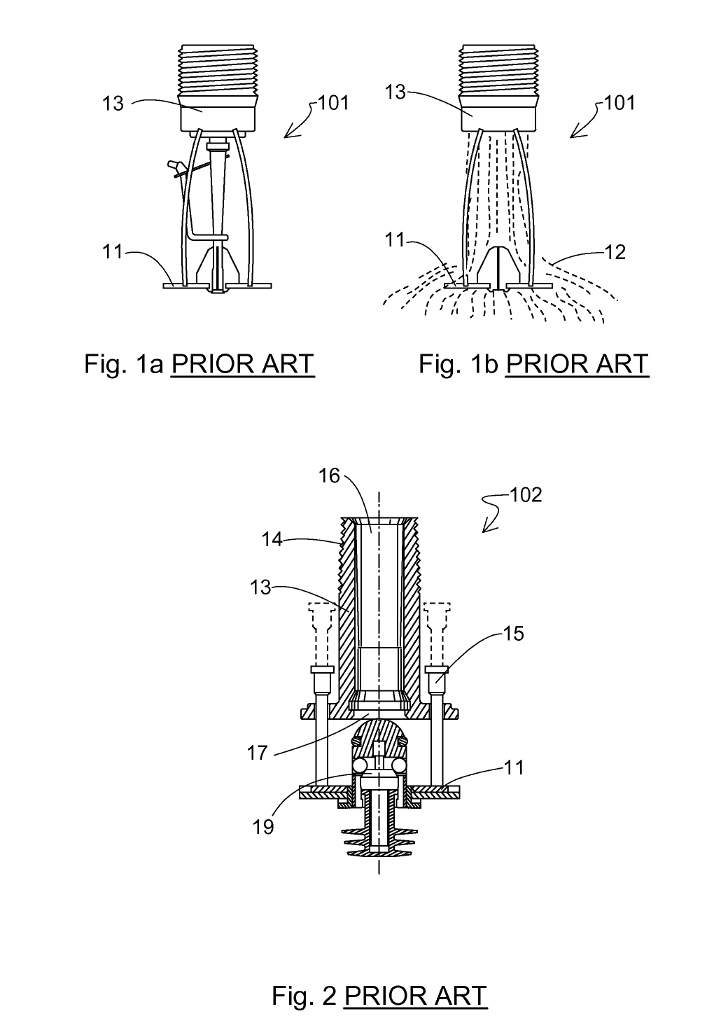

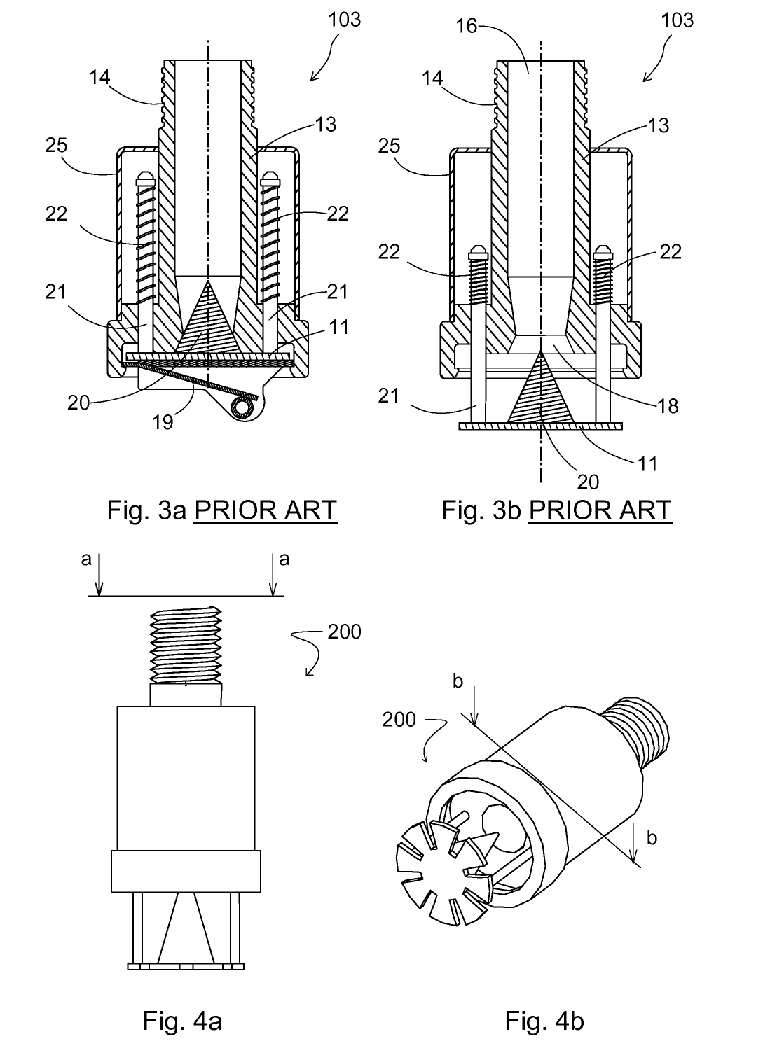

### DETAILED DESCRIPTION OF EMBODIMENTS

The present invention is of a multi application fire sprinkler (MAFS) 200. The principles and operation of a MAFS according to the present invention may be better understood with reference to the drawings and the accompanying description.

Before explaining at least one embodiment of the invention in detail, it is to be understood that the invention is not limited in its application to the details of construction and the arrangement of the components set forth in the following description or illustrated in the drawings.

Unless otherwise defined, all technical and scientific terms used herein have the same meaning as commonly understood by one of ordinary skill in the art to which this invention belongs. The materials, dimensions, methods, and examples provided herein are illustrative only and are not intended to be limiting.

The following list is a legend of the numbering of the application illustrations:
11 deflector assembly
12 water droplets
13 cylindrical body
13a cylindrical body disc
13b cylindrical body disc hole
14 threaded connection
15 struts
16 inlet
17 fixed orifice
18 variable orifice
19 fusible element
20 conical element
20l linear conical element
20w wide conical element
20n narrow conical element
21 arm
22 spiral spring
23 arm screw
24 nut
25 external box
26 movement limiter mechanism
101 automatic fire fixed orifice sprinkler, (prior art)
102 adjustable deflector sprinkler, (prior art)
103 variable orifice sprinkler, (prior art)
200 multi application fire sprinkler (MAFS)

Referring now to the drawings, FIG. 4a is a side view schematic illustration of an illustrative, exemplary embodiment of a multi application fire sprinkler (MAFS) 200, according to the present invention, upon which section plane a-a is marked. The MAFS 200 is shown in the present illustration in an active state.

FIG. 4b is an isometric schematic illustration of an illustrative, exemplary embodiment of a multi application fire sprinkler 200, according to the present invention, upon which section plane b-b is marked. The MAFS 200 is shown in the present illustration in an active state.

The MAFS 200 adapts itself for more efficient work in a wide range of working pressures and enables calibration for a wide variety of fire extinguishment system requirements, thus sparing the need for different types of automatic fire sprinklers with different characteristics.

MAFS 200 enables use of a single type of automatic fire sprinkler by means of a mechanical structure which controls the supply of water flowing through it during its activation, for efficient performance even in the case of changes in working pressure. In addition, its working performance can be significantly improved by enabling the calibration of element parameters and even replacing elements.

Some of the advantages of the MAFS are:
The first MAFS, as opposed to prior art fire sprinklers, provides a maximal quantity of water over the core of the fire, while the total quantity of water sprayed does not exceed standard allotment.
Less fire sprinklers are required for fire extinguishment, and therefore there is less fire and water damage to property.
The MAFS is suitable for all classifications of occupancies and commodities, such as light, ordinary, extra and special hazard occupancies, and commodities.

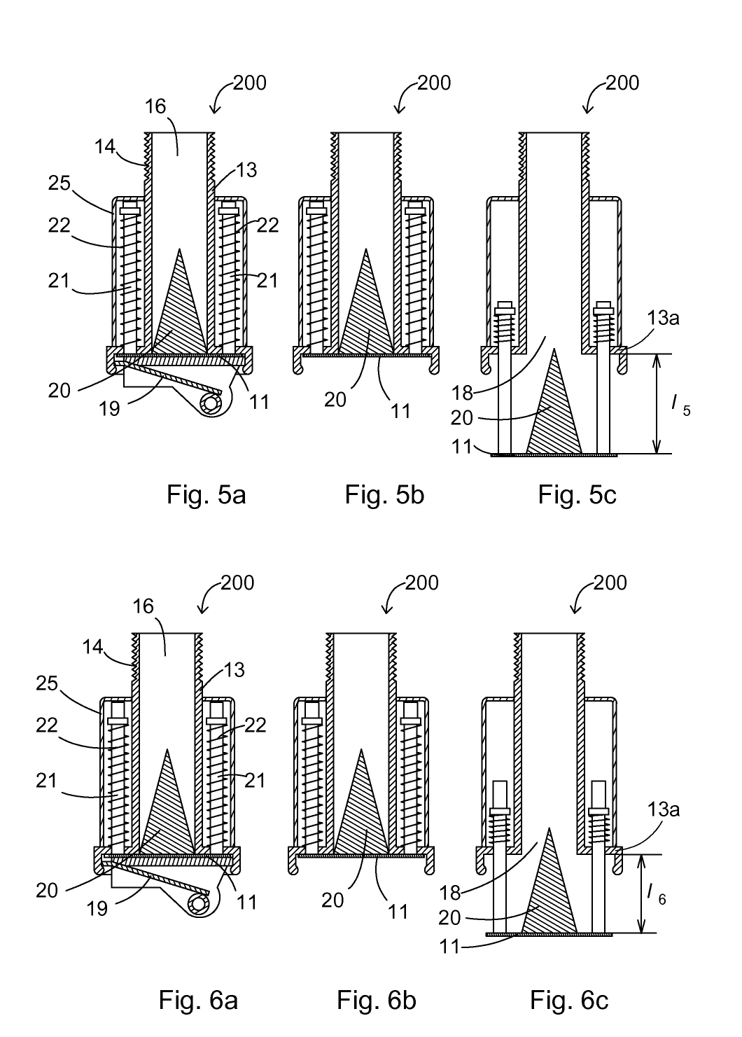

FIGS. 5a, 5b, and 5c are a-a schematic longitudinal cross sectional view illustrations of an illustrative, exemplary embodiment of the multi application fire sprinkler (MAFS) 200, according to the present invention, wherein in the inactive state, which is also maintained when the MAFS is engaged in a fire system and is in standby state, the spiral springs 22 are at their natural length without any load, which practically equals the possible movement length of the deflector assembly 11 up to their full compression.

The mechanical structure of MAFS 200 resembles the structure of the variable orifice sprinkler 103 described above, however includes differences which grant it preferable characteristics. These differences will be described in the following.

MAFS 200 has a variable orifice 18 adjusted by an inner conical element 20, which can have various spatial shapes.

MAFS 200 has a cylindrical body 13 with a threaded connection 14 and can be connected to a water piping system (not shown in the drawing), a deflector assembly 11 tightly closing the cylindrical body 13 in a non-flowing position, in standby or inactive state, thereby preventing water flow through the variable orifice 18. The illustration shows two arms 21 that allow longitudinal movement of deflector assembly 11, so as to increase and decrease the distance between the deflector assembly 11 and cylindrical body disc 13a, and two spiral springs 22 bound around arms 21. The maximum possible length between the deflector assembly 11 and the cylindrical body disc 13a is marked in the illustration as l5.

The cylindrical body disc 13a has, in the case shown in the present illustration, two cylindrical body disc holes (13b), which are suitable to allow through movement of the arms 21 (as will be shown in FIG. 11).

Although the present illustration shows two arms 21, and two spiral springs 22, the present invention is not limited to use of these specific numbers. Likewise, the two arms 21 are practically identical to each other, and the two spiral springs 22 are also identical to each other.

The conical element 20 is associated with the deflector assembly 11. In a non-flowing position the conical element 20 completely penetrates into the cylindrical body 13, closing the variable orifice 18 so as to prevent passage of water in any state of water pressure that may be applied on MAFS 200.

Preferably, arms 21 and springs 22 are protected from external dirt and physical damages by an external box 25.

A non-flowing position is shown in FIG. 5a. The water or other flame retardant fluid is pressurized into the cylindrical body 13 through inlet 16 while the variable orifice (18) is blocked, thus there is no flow through the MAFS 200.

A start position is shown in FIG. 5b. When a fire starts, and heat evolves from the burning materials, fusible element (19) fuses. So, a force resulting from the pressure of water is applied upon the deflector assembly 11 and upon the conical element 20 with the purpose of opening the passage for the flow of water, while a counterforce is applied by the springs with the purpose of closing the passage for the flow of water. The effect of gravity is usually negligibly small with regard to the effects of the other forces described above.

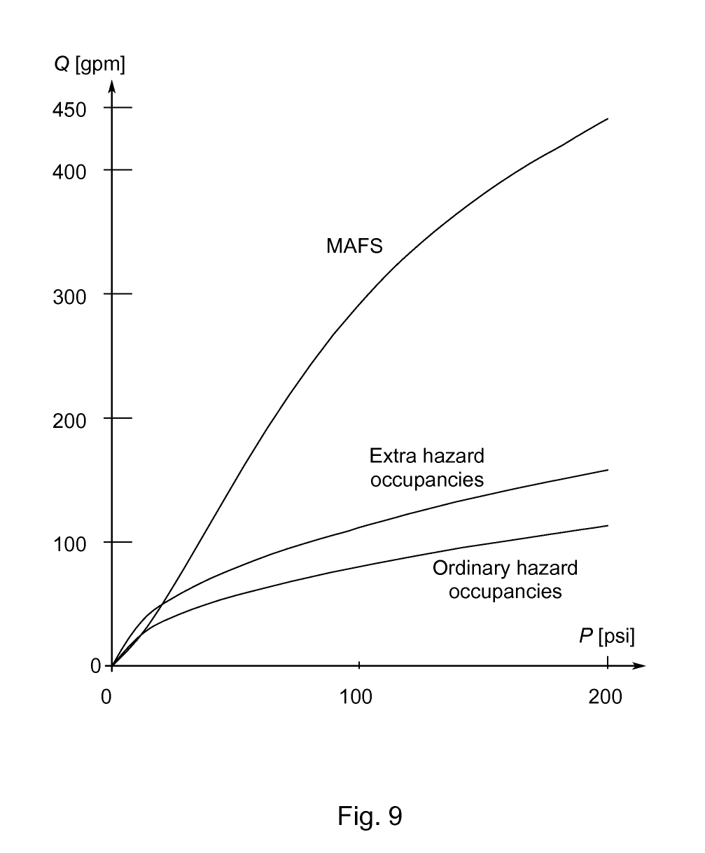

A fully open position is shown in FIG. 5c. When the water pressure applies sufficient force, which overpowers the force applied by the springs, the passage is opened by the lowering of the deflector assembly 11 to the end of its range of movement, namely to length l₅ which is limited by the mechanical structure and will be described in more detail in the following (FIG. 9).

Arms 21 are now at their extreme position outside box 25, and springs 22 are in their most restricted position.

As the pressure of the water flowing through the variable orifice 18 is decreased, springs 22 urge the deflector assembly 11 towards the cylindrical body 13. The cross-sectional area of the penetrating section of conical element 20 increases with decreasing pressure, thereby reducing the cross-sectional area of the water flow-path and further restricting the flow of water discharged by the MAFS 200.

Whenever one multi application fire sprinkler 200 is not sufficient for the fire, more heat is evolved and multi application fire sprinklers 200 are temperature-activated. Consequently, the water pressure in the system decreases and spiral spring 22 pull back a part of arms 21, thus decreasing the gap between the deflector assembly 11 and the cylindrical body 13, part of conical element 20 penetrates into the cylindrical body 13, decreasing variable orifice 18 and the amount of water flowing through the MAFS 200. If additional MAFS 200 are activated, the process continues and the cross-sectional area of the variable orifice 18 further decreases.

FIGS. 6a, 6b, and 6c are a-a schematic longitudinal cross sectional view illustrations of an illustrative, exemplary embodiment of the multi application fire sprinkler (MAFS) 200, according to the present invention, wherein in the inactive state, the spiral springs 22 are compressed relative to their natural state. In this case the possible movement range of the deflector assembly 11 is shorter than when the spiral springs 22 are at their natural length in the inactive state.

A non-flowing position is shown in FIG. 6a. The water or other flame retardant fluid is pressurized into the cylindrical body 13 through inlet 16, and as long as the variable orifice (18) is blocked, there is no flow through the MAFS 200.

A start position is shown in FIG. 6b. When a fire starts, and heat evolves from the burning materials, fusible element (19) fuses. This allows force to be applied by the water pressure upon the deflector assembly 11 and upon the conical element 20 with the purpose of opening the passage for the flow of water, while the springs apply a counterforce with the purpose of closing the passage for the flow of water.

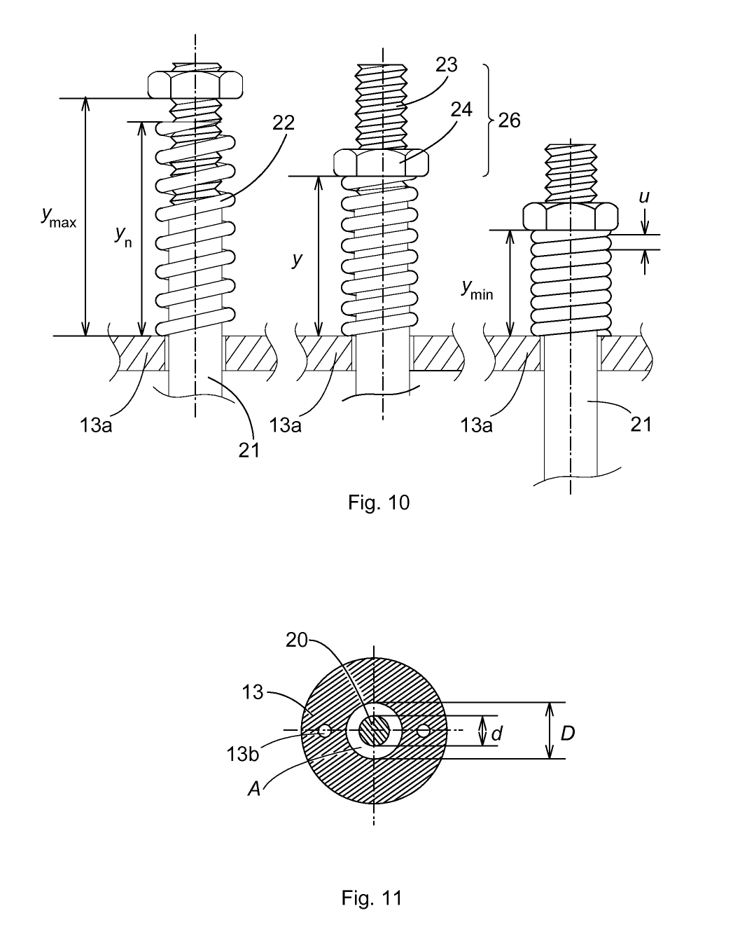

A full open position is shown in FIG. 6c. When the water pressure applies sufficient force, which overpowers the force of the springs, the passage is opened by the lowering of the deflector assembly 11 to the end of its movement range, namely to length l₆, which is limited by the mechanical structure, and will be detailed in the following (FIG. 10).

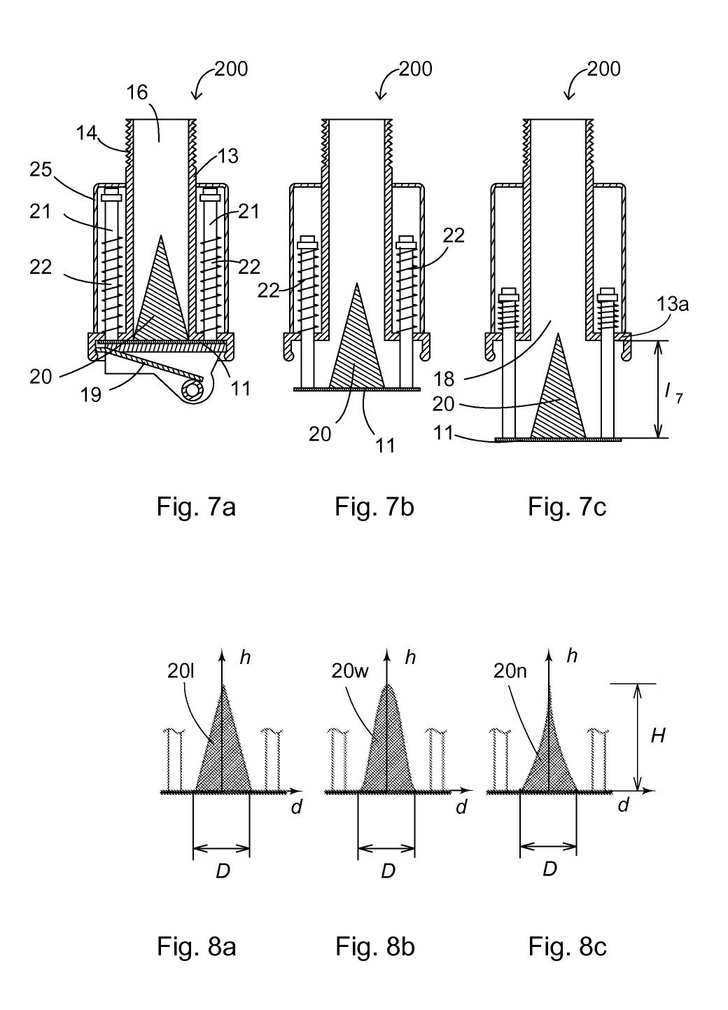

FIGS. 7a, 7b, and 7c are a-a schematic longitudinal cross sectional view illustrations of an illustrative, exemplary embodiment of the multi application fire sprinkler (MAFS) 200, according to the present invention, wherein in the inactive state the spiral springs 22 are at their natural length without any load, with this length being shorter than the possible movement range of the deflector assembly 11 to their full compression.

A non-flowing position is shown in FIG. 7a. The water or other flame retardant fluid is pressurized into the cylindrical body 13 through inlet 16, and as long as the variable orifice 18 is blocked, there is no flow through the MAFS 200.

A start position is shown in FIG. 7b. When a fire starts, and heat evolves from the burning materials, fusible element (19) fuses, and in the state shown, which is suitable for a hanging MAFS 200, the deflector assembly 11 drops until it meets the spiral springs 22. Thus the water pressure applies force upon the deflector assembly 11 with the purpose of increasing the opening for passage of water, while the springs apply a counterforce with the purpose of closing the passage for water.

A fully open position is shown in FIG. 7c. When the water pressure generates sufficient force to overpower the force of the springs, the deflector assembly 11 moves to the end of its possible movement range, namely to length i₇, which is limited by the mechanical structure and will be described in more detail in the following (FIG. 9).

FIGS. 8a, 8b, and 8c, are a-a schematic longitudinal partial cross sectional view illustrations of an illustrative, exemplary embodiment of the multi application fire sprinkler (MAFS) 200, according to the present invention, showing three conical elements 20, each with a different spatial shape. Each conical element 20 has height H and base diameter D, whose values are in the three examples shown in the present illustrations: H=2 inch and D=1.049 inch (D is identical to the internal diameter of the cylindrical body (13), in the segment between the inlet (16) and the variable orifice (18), (which is the standard diameter of a nominal 1 inch SCH 40 steel pipe).

A linear conical element 20l is shown in FIG. 8a, and its formula is:

d=(2−h)×0.5245,

when h is measured from the base of the cone to its vertex.

A wide conical element 20w is shown in FIG. 8b, and its formula is:

d=(1.1−0.778×h^{1/2})^{1/2}.

A narrow conical element 20n is shown in FIG. 8c, and its formula is:

d=(2−h)²×0.262.

Note that these three examples of conical elements are not the only possible options of shape and dimension and do not limit the present invention in any way.

The formulas can be more generalized as follows:

A linear conical element formula is:

d=A×c₂=(c₁−h)×c₂,

when h is measured from the base of the cone to its vertex.

A wide conical element formula is:

d=Bⁿ²=(c₃−C)ⁿ²=(c₃−c₄×hⁿ¹)ⁿ².

A narrow conical element formula is:

d=Dⁿ³×c₆=(c₅−h)ⁿ³×c₆.

The performance of the MAFS in any specific configuration and any specific calibration conditions can be determined through experimentation, thus standardization institutes can determine rigid standards for adaptation of each MAFS for its designation.

The structure and qualities of the MAFS enable it to work efficiently also outside of the range of pressures currently defined as the standard, which is 7-175 psi, and even at the maximal water pressure that practical water piping can provide.

Each type of conical element has a unique corresponding function ƒ, with the general form of the supply equation as a function of pressure being:

Q=ƒ(P)

When ƒ can be found through experimentation.

Table 1 shows numerical figures enabling comparison of the water flow rate as a function of the pressure of the MAFS to the present invention, equipped with a narrow conical element 20, with the water flow rate of two prior art fire sprinklers, one of which is suitable for Ordinary Hazard occupancies and the other of which is suitable for Extra Hazard occupancies.

This data is of a specific case of calibration of the MAFS and its performance can be adapted to other specific conditions.

TABLE 1

| | | | | Prior Art Fire Sprinkler | |
|---|---|---|---|---|---|
| | | | | Hazard Occupancies | |
| MAFS | | | | Ordinary | Extra |
| h [in] | d [in] | P [psi] | Q [gpm] | Q [gpm] | Q [gpm] |
| 2.0 | 0.000 | 200 | 441 | 113 | 158 |
| 1.9 | 0.003 | 190 | 430 | 110 | 154 |
| 1.8 | 0.010 | 180 | 418 | 107 | 150 |
| 1.7 | 0.024 | 170 | 407 | 104 | 146 |
| 1.6 | 0.042 | 160 | 394 | 101 | 142 |
| 1.5 | 0.066 | 150 | 381 | 98 | 137 |
| 1.4 | 0.094 | 140 | 366 | 95 | 133 |
| 1.3 | 0.129 | 130 | 350 | 91 | 128 |
| 1.2 | 0.168 | 120 | 333 | 88 | 123 |
| 1.1 | 0.212 | 110 | 314 | 84 | 117 |
| 1.0 | 0.262 | 100 | 292 | 80 | 112 |
| 0.9 | 0.317 | 90 | 269 | 76 | 106 |
| 0.8 | 0.378 | 80 | 243 | 72 | 100 |
| 0.7 | 0.443 | 70 | 214 | 67 | 94 |
| 0.6 | 0.514 | 60 | 184 | 62 | 87 |
| 0.5 | 0.590 | 50 | 151 | 57 | 79 |
| 0.4 | 0.671 | 40 | 116 | 51 | 71 |
| 0.3 | 0.758 | 30 | 82 | 44 | 61 |
| 0.2 | 0.850 | 20 | 48 | 36 | 50 |
| 0.1 | 0.947 | 10 | 18 | 25 | 35 |
| 0.0 | 1.049 | 0 | 0 | 0 | 0 |

### Performance Comparison

FIG. 9 is a graph describing the water flow rate as a function of the pressure of the MAFS according to the present invention, equipped with a narrow conical element (20), and the water flow rate of two prior art fire sprinklers, one of which is suitable for Ordinary Hazard occupancies, and the other of which is suitable for Extra Hazard occupancies, according to the details of Table 1.

FIG. 10 is a side view illustration of an illustrative, exemplary embodiment of arm 21, spiral spring 22, and deflector assembly 11 of the MAFS 200, according to the present invention, in three different states. This illustration demonstrates the movement limitations of the deflector assembly (11). On the upper part of arm 21 is a movement limiter mechanism 26. This mechanism can be easily adjusted for adaptation to desired functions and working conditions. In the present illustration, the mechanism includes arm screw 23 and nut 24. The left side of the illustration shows movement limiter mechanism 26 in a state in which nut 24 is at a distance from the cylindrical body 13a (the cylindrical body horizontal part) whose size yₘₐₓ is larger than the natural size yₙ, namely the unloaded size, of spiral spring 22. This state is suitable for the position described in FIG. 7a.

The center of the illustration shows a state in which nut 24 is at a distance y from the cylindrical body 13a, and so it presses toward it and compresses it. This state is suitable for the non-flowing position shown in FIG. 6a and for intermediary states, with regard to the movement of deflector assembly (11).

The right side of the illustration shows a state in which the movement limiter mechanism 26 limits the downward movement of the arm 21 and thus also the movement of the deflector assembly (11). This limitation occurs when nut 24 is at a distance of yₘᵢₙ from the cylindrical body 13a, when it equals the length of the fully compressed spiral spring 22, namely it equals the product of the number of its coils by the width of its wire u.

FIG. 11 is a b-b schematic lateral partial cross sectional view illustration of an illustrative, exemplary embodiment of the multi application fire sprinkler (MAFS) 200, according to the present invention. The illustration shows area A of the variable orifice 18 through which there can be flow. This area is between section areas of the cylindrical body 13, whose diameter is D, and the conical element 20, whose variable diameter is d.

Cylindrical body disc 13a has, in the case shown in the present illustration, two cylindrical body disc holes 13b, which enable through movement of the arms (21).

While the invention has been described with respect to a limited number of embodiments, it will be appreciated that many variations, modifications and other applications of the invention may be made.

While the invention has been described with respect to a limited number of embodiments, it will be appreciated that many variations, modifications and other applications of the invention may be made, and in particular the present invention does not limit use of the MAFS for any specific range of water pressures, any specific hanging orientation, vertical or other, any specific type of deflector assembly, or any specific type of activation mechanism such as ordinary or fast response.

What is claimed:

1. A multi application fire sprinkler comprising:
(a) a cylindrical body, having an inlet at one end and a variable orifice at a second end of said cylindrical body, and a cylindrical body disc;
(b) at least one arm, wherein said arm is mounted through a cylindrical body disc hole;
(c) at least one spiral spring disposed around said at least one arm;
(d) a deflector assembly disposed on said at least one arm;
(e) a movement limiter mechanism disposed on said at least one arm, wherein said at least one spiral spring is located between said cylindrical body disc and said movement limiter mechanism; and
(f) a conical element disposed on said deflector assembly, wherein the combination of said conical element, said at least one arm, and said at least one spiral spring determine a water flow rate through said variable orifice according to water pressure.

2. The multi application fire sprinkler of claim 1, wherein said conical element is a linear conical element.

3. The multi application fire sprinkler of claim 1, wherein said conical element is a narrow conical element.

4. The multi application fire sprinkler of claim 1, wherein said conical element is a wide conical element.

5. A multi application fire sprinkler comprising:
(a) a cylindrical body, having an inlet at one end and a variable orifice at a second end of said cylindrical body, and a cylindrical body disc;
(b) at least one arm, wherein said arm is mounted through a cylindrical body disc hole;
(c) at least one spiral spring disposed around said at least one arm;
(d) a deflector assembly disposed on said at least one arm;
(e) a movement limiter mechanism disposed on said at least one arm, wherein said at least one spiral spring is located between said cylindrical body disc and said movement limiter mechanism; and
(f) a conical element disposed on said deflector assembly, wherein said conical element can be selected from a group consisting of a linear conical element, a wide conical element, and a narrow conical element, and wherein the combination of said conical element, said at least one arm, and said at least one spiral spring determine a water flow rate through said variable orifice according to water pressure.

6. The multi application fire sprinkler of claim 5, wherein in an inactive state of said multi application fire sprinkler said at least one spiral spring is practically at its natural length, which practically equals a possible movement length of said deflector assembly up to its full compression, wherein one end of said at least one spiral spring is in touch with said cylindrical body disc, and wherein a second end of said at least one spiral spring is in touch with said movement limiter mechanism.

7. The multi application fire sprinkler of claim 5, wherein in an inactive state of said multi application fire sprinkler said at least one spiral spring is compressed relative to its natural state, wherein a possible movement range of said deflector assembly is shorter than a length of said at least one spiral springs natural length, wherein one end of said at least one spiral spring is in touch with said cylindrical body disc, and wherein a second end of said at least one spiral spring is in touch with said movement limiter mechanism.

8. The multi application fire sprinkler of claim 5, wherein in an inactive state of said multi application fire sprinkler said at least one spiral spring is practically at its natural length, wherein said natural length is shorter than a possible movement range of said deflector assembly to a full compression length of said at least one spiral spring.

9. The multi application fire sprinkler of claim 5, wherein a position of an element of said movement limiter mechanism on said at least one arm can be manually adjusted for adaptation to desired functions and working conditions of said multi application fire sprinkler.

10. The multi application fire sprinkler of claim 9, wherein said element of said movement limiter mechanism is a nut.

11. The multi application fire sprinkler of claim 5, wherein said multi application fire sprinkler is configured such that said at least one spiral spring can be manually replaced easily, with an alternative spiral spring.

12. The multi application fire sprinkler of claim 2, wherein said linear conical element has cross section diameter, perpendicular to a symmetry axis of said linear conical element, is equals to the mathematical product of A and a constant c sub 2, wherein A equals a constant c sub 1 minus h, wherein h is a distance measured from said cone base, towards a cone vertex of said linear conical element.

13. The multi application fire sprinkler of claim 12, wherein said constant c sub 1 practically equals 2.0, and wherein said constant c sub 2 practically equals 0.5245.

14. The multi application fire sprinkler of claim 3, wherein said narrow conical element has cross section diameter, perpendicular to a symmetry axis of said narrow conical element equals the mathematical product of D to the power of n3 and a constant c sub 6, wherein D equals a constant c sub 5 minus h, wherein h is a distance, measured from said cone base, towards a cone vertex of said narrow conical element.

15. The multi application fire sprinkler of claim 14, wherein said n3 is practically equals to 2.0, wherein said constant c sub 5 is practically equals to 2.0, and wherein said constant c sub 6 is practically equals to 0.262.

16. The multi application fire sprinkler of claim 4, wherein said wide conical element has a cross section diameter, perpendicular to a symmetry axis of said wide conical element, which equals B to the power of n2, wherein B equals a constant c sub 3 minus C, wherein C equals the mathematical product of h to the power of n1 and a constant c sub 4, wherein h is a distance, measured from said cone base, towards a cone vertex of said wide conical element.

17. The multi application fire sprinkler of claim 16, wherein said n1 practically equals 0.5, wherein said n2 is practically equals 0.5, wherein said constant c sub 3 practically equals 1.1, and wherein said constant c sub 4 practically equals 0.778.
